(19) United States
(12) Patent Application Publication
(10) Pub. No.: US 2026/0129596 A1
(43) Pub. Date: May 7, 2026

(54) WIRELESS COMMUNICATION METHOD, TERMINAL DEVICE, AND NETWORK DEVICE

(71) Applicant: QUECTEL WIRELESS SOLUTIONS CO., LTD., Shanghai (CN)

(72) Inventors: Zheng ZHAO, Shanghai (CN); Ling LYU, Frisco, TX (US)

(21) Appl. No.: 19/437,818

(22) Filed: Dec. 31, 2025

Related U.S. Application Data
(63) Continuation of application No. PCT/CN2024/124835, filed on Oct. 14, 2024.

(51) Int. Cl. H04W 56/00; H04W 76/20; H04W 80/02

(52) U.S. Cl. CPC H04W 56/0015; H04W 76/20; H04W 80/02

(57) ABSTRACT

Disclosed are a wireless communication method, a terminal device, and a network device. One example method includes: receiving, by a terminal device, first information from a network device, wherein the first information indicates a plurality of periodicity configurations for receiving synchronization signal/physical broadcast channel blocks (SSBs).

### CROSS-REFERENCE TO RELATED APPLICATIONS

This application is a continuation of International Application No. PCT/CN2024/124835, filed on Oct. 14, 2024, the disclosure of which is hereby incorporated by reference in its entirety.

### TECHNICAL FIELD

The present application relates to the field of communications technologies, and more specifically, to a wireless communication method, a terminal device, and a network device.

### BACKGROUND

A synchronization signal/physical broadcast channel block (synchronization signal/physical broadcast channel block, SS/PBCH block, SSB) may facilitate initial synchronization and connection with a base station, but SSB transmission may affect power consumption of a system. Therefore, the SSB transmission needs to be improved to achieve energy saving without affecting SSB performance.

### SUMMARY

The present application provides a wireless communication method, a terminal device, and a network device. Various aspects used in the present application are described below.

According to a first aspect, a wireless communication method is provided. The method includes: receiving, by a terminal device, first information transmitted by a network device, where the first information indicates a plurality of periodicity configurations for receiving synchronization signal/physical broadcast channel blocks SSBs.

According to a second aspect, a wireless communication method is provided. The method includes: transmitting, by a network device, first information to a terminal device, where the first information indicates a plurality of periodicity configurations for receiving synchronization signal/physical broadcast channel blocks SSBs.

According to a third aspect, a terminal device is provided. The terminal device includes a transceiver unit, receiving first information transmitted by a network device, where the first information indicates a plurality of periodicity configurations for receiving synchronization signal/physical broadcast channel blocks SSBs.

According to a fourth aspect, a network device is provided. The network device includes a transceiver unit, transmitting first information to a terminal device, where the first information indicates a plurality of periodicity configurations for receiving synchronization signal/physical broadcast channel blocks SSBs.

According to a fifth aspect, a terminal device is provided, and the terminal device includes a transceiver, a memory, and a processor. The memory is configured to store a program, and the processor is configured to: invoke a program in the memory, and control the transceiver to receive or transmit a signal, to cause the terminal device to perform the method according to the first aspect.

According to a sixth aspect, a network device is provided, and the network device includes a transceiver, a memory, and a processor. The memory is configured to store a program, and the processor is configured to: invoke a program in the memory, and control the transceiver to receive or transmit a signal, to cause the network device to perform the method according to the second aspect.

According to a seventh aspect, an apparatus is provided, including a processor, invoking a program from a memory, to cause the apparatus to perform the method according to any one of the first aspect or the second aspect.

According to an eighth aspect, a chip is provided, including a processor, invoking a program from a memory to cause a device installed with the chip to perform the method according to any one of the first aspect or the second aspect.

According to a ninth aspect, a computer-readable storage medium is provided, where a program is stored on the computer-readable storage medium, and the program causes a computer to perform the method according to any one of the first aspect or the second aspect.

According to a tenth aspect, a computer program product is provided, where the computer program product includes a program, and the program causes a computer to perform the method according to the first aspect or the second aspect.

According to an eleventh aspect, a computer program is provided, where the computer program causes a computer to perform the method according to the first aspect or the second aspect.

In embodiments of the present application, a plurality of periodicities for SSB transmission are configured for the terminal device by using the first information, so that the SSB transmission is more flexible, and energy saving can be achieved without affecting SSB performance.

### BRIEF DESCRIPTION OF THE DRAWINGS

FIG. 1 is an example diagram of a system architecture of a wireless communications system applicable to embodiments of the present application.

FIG. 2 is a schematic diagram of an SSB burst.

FIG. 3 is a schematic flowchart of a wireless communication method according to an embodiment of the present application.

FIG. 4 is a schematic diagram of a topological structure between a terminal device and base stations.

FIG. 5 is a schematic flowchart of a wireless communication method according to another embodiment of the present application.

FIG. 6 is a schematic flowchart of a wireless communication method according to another embodiment of the present application.

FIG. 7 is a schematic diagram of a possible location of a first instant according to an embodiment of the present application.

FIG. 8 is a schematic diagram of a possible location of a first instant according to an embodiment of the present application.

FIG. 9 is a schematic diagram of a possible location of a first instant according to an embodiment of the present application.

FIG. 10 is a schematic diagram of a possible location of a first instant according to an embodiment of the present application.

FIG. 11 is a schematic diagram of a possible location of a first instant according to an embodiment of the present application.

FIG. 12 is a schematic structural diagram of a terminal device according to an embodiment of the present application.

FIG. 13 is a schematic structural diagram of a network device according to an embodiment of present application.

FIG. 14 is a schematic diagram of an apparatus for communication according to an embodiment of the present application.

### DETAILED DESCRIPTION OF THE EMBODIMENTS

The technical solutions in the present application are described below with reference to the accompanying drawings.

### Wireless Communications System

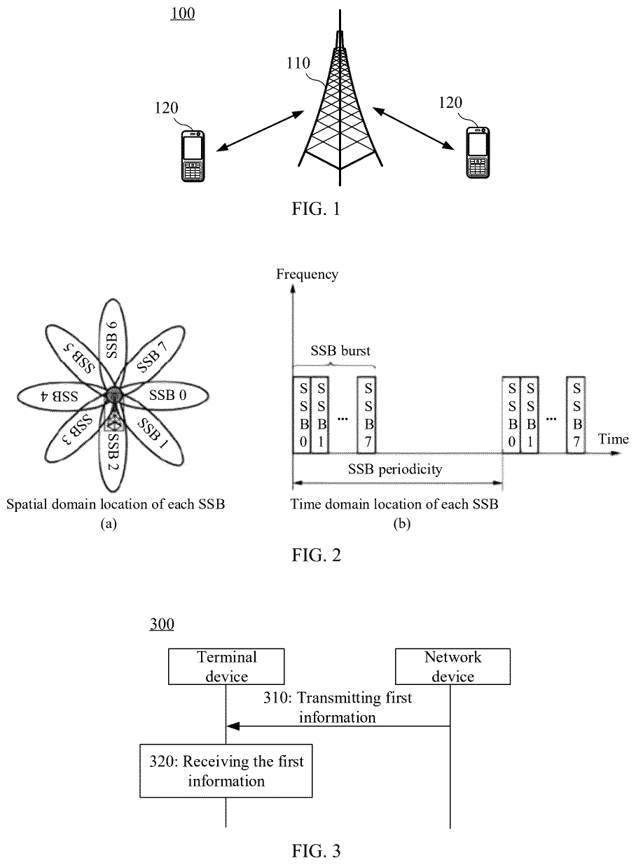

FIG. 1 is an example diagram of a system architecture of a wireless communications system 100 to which an embodiment of the present application is applicable. The wireless communications system 100 may include a network device 110 and a terminal device 120. The network device 110 may be a device that communicates with the terminal device 120. The network device 110 may provide communication coverage for a specific geographical area, and may communicate with the terminal device 120 located within the coverage. The terminal device 120 may access a network, for example, a wireless network, by using the network device 110. Optionally, the wireless communications system 100 may further include other network entities such as a network controller and a mobility management entity, which is not limited in embodiments of the present application.

It should be understood that the technical solutions of embodiments of the present application may be applied to various communications systems, such as a 5^{th} generation (fifth generation, 5G) system or a new radio (new radio, NR) system, a long term evolution (long term evolution, LTE) system, an LTE frequency division duplex (frequency division duplex, FDD) system, and an LTE time division duplex (time division duplex, TDD) system. The technical solutions provided in the present application may further be applied to a future communications system, such as a 6th generation mobile communications system or a satellite communications system.

The terminal device in embodiments of the present application may alternatively be referred to as a user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, or a user apparatus. The terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone (mobile phone), a tablet computer (Pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the terminal device may be configured to function as a base station. For example, the terminal device may function as a scheduling entity that provides a sidelink signal between terminal devices in vehicle-to-everything (vehicle to everything, V2X), device-to-device (device to device, D2D), or the like. For example, a cellular phone and a vehicle communicate with each other by using a sidelink signal. A cellular phone and a smart household device communicate with each other, without the relay of a communication signal through a base station.

The network device in embodiments of the present application may be a device configured to communicate with the terminal device. The network device may be, for example, an access network device or a wireless access network device. For example, the network device may be a base station. The base station may broadly cover the following various names, or may be replaced with the following names: a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNodeB (MeNB), a secondary eNodeB (SeNB), a multi-standard radio (MSR) node, a home base station, a network controller, an access node, a wireless node, an access point (access point, AP), a transmission node, a transceiver node, a baseband unit (baseband unit, BBU), a remote radio unit (remote radio unit, RRU), an active antenna unit (active antenna unit, AAU), a remote radio head (remote radio head, RRH), a centralized unit (centralized unit, CU), a distributed unit (distributed unit, DU), a positioning node, and the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communications, a network-side device in a 6G network, a device that functions as a base station in a future communications system, or the like. The base station may support networks of a same access technology or different access technologies. A specific technology and a specific device form used by the network device are not limited in embodiments of the present application.

The base station may be fixed or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device in communication with another base station.

In some deployments, the network device may be a CU or a DU; or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or some of functions of the communications device in the present application may also be implemented by software functions running on hardware, or by virtualization functions instantiated on a platform (for example, a cloud platform).

### SSB

In an NR system, each SSB is used for initial access and synchronization. The SSB includes three parts: a primary synchronization signal (primary synchronization signal, PSS), a secondary synchronization signal (secondary synchronization signal, SSS), and a physical broadcast channel (PBCH). The PSS and SSS are used for time-frequency synchronization, which may be beneficial for a terminal device to find synchronization information of a network device. The PBCH carries basic system information to ensure that a terminal receives higher-layer signals and configurations. The SSB is broadcast periodically in the NR system, and a periodicity may be configured to 5 ms, 10 ms, 20 ms, or the like. This means that the network device periodically transmits SSB signals to ensure that a new terminal device may discover a network and be connected to the network. In actual operation, the base station may adjust a transmit power of an SSB based on factors such as coverage and user density. Larger coverage may require a higher transmit power, which results in greater power consumption.

In the NR system, the SSB is transmitted directionally through beamforming (Beamforming). Each beam includes an SSB, and the base station may configure a plurality of beams to cover different directions. SSBs required to complete one time of beam sweeping may constitute an SSB burst (SSB burst). Generally, a transmission configuration of an SSB burst in time, frequency or spatial domain may be described by a pattern of the SSB burst, for example, SSB beam sweeping and an SSB burst set transmission time shown in FIG. 2, where (a) in FIG. 2 shows a spatial domain beam for transmitting each SSB, and (b) in FIG. 2 shows a time domain location for transmitting each SSB. The pattern of the SSB burst may vary in different frequency bands and configurations. For example, in different frequency bands, a maximum number of SSBs that may be included in one SSB burst may be 4, 8, 64, or the like. Different SSBs have different SSB indexes (SSB indexes). In FIG. 2, that one SSB burst includes eight SSB indexes, namely, SSB 0 to SSB 7, is used as an example.

A larger quantity of beams means more SSB transmissions, which in turn increases power consumption. Advanced multiple input multiple output (multiple input multiple output, MIMO) antenna configurations also affect a transmit power and power consumption of an SSB. For example, a 64T64R (64 transmit and 64 receive) antenna may consume more power than a lower order antenna configuration. In an environment in which small base stations (for example, micro base stations, macro base stations) are densely deployed, coverage of an SSB is relatively small and power consumption of the SSB is relatively reduced. However, a cumulative power consumption of a plurality of base stations is still large.

Therefore, an embodiment of the present application provides a wireless communication method. A plurality of periodicities for SSB transmission are configured for a terminal device by using first information, so that SSB transmission is more flexible, and energy saving can be achieved without affecting SSB performance.

The following describes the embodiment of the present application in detail with reference to FIG. 3.

FIG. 3 is a schematic flowchart of a wireless communication method according to an embodiment of the present application. The method 300 shown in FIG. 3 may be performed by a terminal device and a network device. The terminal device may be, for example, the terminal device 120 shown in FIG. 1, and the network device may be, for example, the network device 110 shown in FIG. 1.

Referring to FIG. 3, in Step 310, the network device transmits first information to the terminal device.

Correspondingly, in Step 320, the terminal device receives the first information transmitted by the network device.

The first information indicates a plurality of periodicity configurations for SSB transmission. In other words, the first information indicates a plurality of periodicity configurations for receiving SSBs. In this embodiment of the present application, the receiving SSBs may alternatively be replaced by measuring SSBs or detecting SSBs. The SSB described in this embodiment of the present application may refer to an SSB burst, or one or more SSB indexes in an SSB burst.

In this embodiment of the present application, SSB transmission may have a plurality of periodicities. For example, when there is a high network load, a switch may be made to a shorter periodicity for SSB transmission, and when there is a low network load, a switch may be made to a longer periodicity for SSB transmission. In this way, the SSB transmission is more flexible, and energy saving can be achieved without affecting SSB performance.

Each of the plurality of periodicity configurations may include one or more periodicities. As an example, each periodicity configuration includes one periodicity. It is assumed that a periodicity configuration 1 includes a periodicity T1, a periodicity configuration 2 includes a periodicity T2, the periodicity T1 may be a longer periodicity, and the periodicity T2 may be a shorter periodicity. As another example, each periodicity configuration includes a plurality of periodicities. It is assumed that a periodicity configuration 1 includes a periodicity T11 and a periodicity T12, where the periodicity T11 may be a longer periodicity, and the periodicity T12 may be a shorter periodicity; and a periodicity configuration 2 includes a periodicity T21 and a periodicity T22, where the periodicity T21 may be a longer periodicity, and the periodicity T22 may be a shorter periodicity.

In some implementations, different periodicity configurations include periodicities having an integral multiple relationship; and/or a same periodicity configuration includes periodicities having an integral multiple relationship. As an example, periodicities that may be used to transmit SSBs may be periodicities having an integral multiple relationship, such as 20 milliseconds, 40 milliseconds, 60 milliseconds, 80 milliseconds, and 160 milliseconds. For example, the periodicity T1 and the periodicity T2 belonging to different periodicity configurations have an integral multiple relationship. The periodicity T1 may be an integer multiple of the periodicity T2, for example, the periodicity T1 is 160 milliseconds, and the periodicity T2 is 20 milliseconds, or the periodicity T1 is 120 milliseconds, and the periodicity T2 is 40 milliseconds. As another example, the periodicity T11 and the periodicity T12 belonging to a same periodicity configuration may have an integral multiple relationship. The periodicity T11 may be an integer multiple of the periodicity T12, for example, the periodicity T11 is 160 milliseconds, and the periodicity T12 is 20 milliseconds, or the periodicity T11 is 120 milliseconds, and the periodicity T12 is 40 milliseconds. As another example, the periodicity T21 and the periodicity T22 belonging to a same periodicity configuration may have an integral multiple relationship. The periodicity T21 may be an integer multiple of the periodicity T22, for example, the periodicity T21 is 160 milliseconds, and the periodicity T22 is 20 milliseconds, or the periodicity T21 is 120 milliseconds, and the periodicity T22 is 40 milliseconds.

In some implementations, the plurality of periodicity configurations may be associated with different SSB bursts (for example, SSB bursts transmitted at different times); or the plurality of periodicity configurations may be associated with different SSB index groups (for example, different index groups in SSB bursts). The SSB index group may include one SSB index or a plurality of SSB indexes. Periodicities in the periodicity configurations associated with the different SSB index groups may be the same. In this case, it may be considered that the plurality of periodicity configurations are associated with the SSB index groups to form SSB bursts. Alternatively, the periodicity configurations associated with the different SSB index groups may be different, for example, periodicities included in the periodicity configurations associated with the different SSB index groups are completely different or partially different. As an example, the plurality of periodicity configurations in the first information are associated with different SSB index groups, and the plurality of configurations include a periodicity configuration 1 and a periodicity configuration 2, where the periodicity configuration 1 is used to transmit an SSB index group 1, and the periodicity configuration 2 is used to transmit an SSB index group 2, the periodicity configuration 1 may include one or more periodicities for transmitting the SSB index group 1, the periodicity configuration 2 may include one or more periodicities for transmitting the SSB index group 2, and SSB indexes included in the SSB index group 1 and the SSB index group 2 may be partially or completely different. In addition, a number of SSB indexes included in the SSB index group 1 and a number of SSB indexes included in the SSB index group 2 may be the same or different.

SSB transmission is performed in a beam sweeping manner. In different beam directions, a delay of service measurement required by the terminal device may be different. For example, in some directions, the terminal device has strong mobility, and the terminal device in these directions needs to perform SSB measurement frequently. Alternatively, in a case in which some in-vehicle services require relatively fast inter-cell handover, the terminal device also needs to perform relatively fast SSB measurement. For example, some beams of a base station cover a highway, while some beams cover an ordinary road and farmland in a cell. An SSB in a direction of covering the highway needs to have a shorter measurement period than an SSB in a direction of covering the ordinary road and farmland in the cell. Therefore, associating a periodicity for transmitting an SSB with an SSB index ensures detection performance of an SSB in a specific direction and reduces power consumption caused by SSB transmission in another direction.

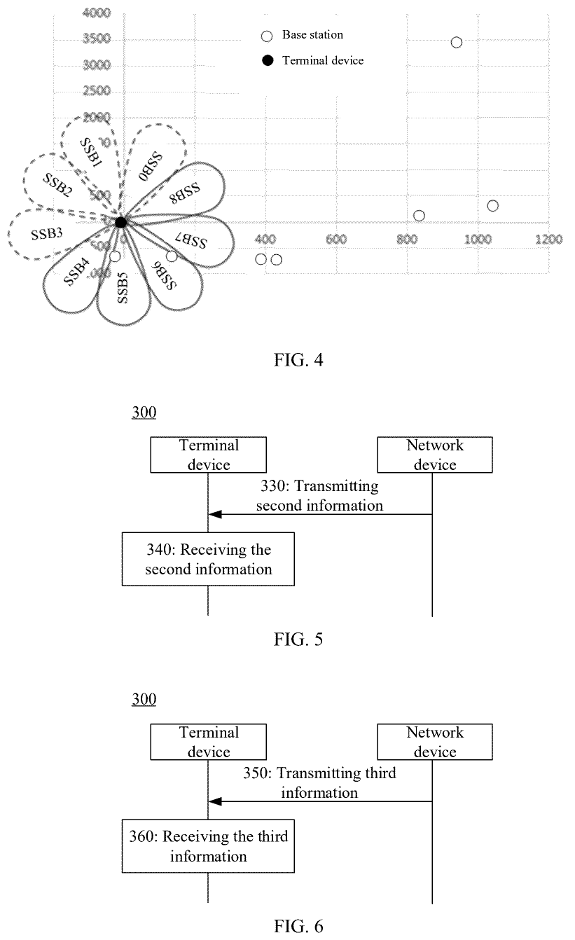

As an example, a topological structure between a terminal device and base stations is shown in FIG. 4, where an SSB burst includes eight SSB indexes, namely, an SSB 0, an SSB 1, an SSB 2, an SSB 3, an SSB 4, an SSB 5, an SSB 6, and an SSB 7. The SSB 0, the SSB 1, the SSB 2, and the SSB 3 belong to an SSB index group 1, and the SSB 4, the SSB 5, the SSB 6, and the SSB7 belong to an SSB index group 2. It is assumed that in an area covered by the SSB 4, the SSB 5, the SSB 6, and the SSB7 in the index group 2, the terminal device needs to perform relatively fast cell handover and relatively fast SSB measurement, while in an area covered by the SSB 0, the SSB 1, the SSB 2, and the SSB 3 in the index group 1, the terminal device does not need to perform frequent SSB measurement. Thus, the index group 1 may be associated with a longer periodicity, and the index group 2 may be associated with a shorter SSB periodicity. The network device may notify the terminal device of the periodicity configuration 1 associated with the SSB index group 1 and the periodicity configuration 2 associated with the SSB index group 2 by using the first information. For example, the periodicity configuration 1 includes the SSB 0, the SSB 1, the SSB 2, and the SSB 3, and the corresponding periodicity T1, and the periodicity configuration 2 includes the SSB 4, the SSB 5, the SSB 6, and the SSB7, and the corresponding periodicity T2. T1 may be greater than T2. For example, T1 may be an integer multiple of T2. Each SSB burst sent by the network device may include some SSB indexes from the SSB 0 to the SSB 7. For an SSB index belonging to the index group 1, the terminal device may perform corresponding SSB measurement based on the periodicity T1 in the periodicity configuration 1, and for an SSB index belonging to the index group 2, the terminal device may perform corresponding SSB measurement based on the periodicity T2 in the periodicity configuration 1.

In some implementations, the first information is transmitted during a cell configuration of the terminal device, and the cell configuration includes one or more of the following: cell access, cell handover, or adding a secondary cell. That is, when a new cell is configured for the terminal device, the first information may be used to indicate a plurality of periodicities for SSB transmission. The new cell may be a new cell (or a target cell) in a process of cell access, cell handover, or adding a secondary cell.

The first information may be carried in, for example, radio resource control (radio resource control, RRC) signalling, broadcast signalling, multicast signalling, or system information.

In some implementations, the plurality of periodicities are associated with the terminal device. That is, a plurality of periodicities configured for different terminal devices may be different, for example, partially or completely different. In this case, the first information may be carried in RRC signalling. If the plurality of periodicities are not associated with terminal devices, a plurality of periodicities configured for all terminal devices in a cell or a group are the same. In this case, the first information may be carried in multicast signalling or broadcast signalling, and the first information sent by the network device is applicable to all the terminal devices in the cell or the group.

In some implementations, a periodicity for receiving an SSB is the same as a periodicity for transmitting an SSB by the network device; or there is an integral multiple relationship between a periodicity for receiving an SSB and a periodicity for transmitting an SSB by the network device. That is, the periodicity used by the network device to send an SSB may be the same as or different from the periodicity used by the terminal device to receive an SSB (for example, there is an integral multiple relationship between the periodicities). As an example, it is assumed that the network device transmits SSBs with a periodicity of 40 ms, while the network device notifies the terminal device that a plurality of periodicities for receiving SSBs include 80 ms and 160 ms. The terminal device needs to measure SSBs at a periodicity of 80 ms and at a periodicity of 160 ms, and does not need to measure SSBs at the periodicity of 40 ms when the network device actually transmits SSBs. In this case, although power consumption of the network device is still power consumption caused by the SSB transmission with a periodicity of 40 ms, power consumption of the terminal device is reduced from a perspective of the terminal device.

In some implementations, the first information may be further used to indicate a number of periodicities of continuous reception of SSBs. That is, the first information indicates a number of periodicities in which the terminal device continuously receives SSBs.

In some implementations, as shown in FIG. 5, the method 300 may further include Step 330 and Step 340.

In Step 330, the network device transmits second information to the terminal device.

Correspondingly, in Step 340, the terminal device receives the second information transmitted by the network device.

The second information is used to indicate a target periodicity that is activated (that is, a periodicity used by an SSB that is currently being transmitted or that is to be transmitted) in the plurality of periodicities. Optionally, the plurality of periodicities may be periodicities in different periodicity configurations, or different periodicities in a same periodicity configuration. In other words, the plurality of periodicities respectively belong to different periodicity configurations (for example, different periodicity configurations associated with SSB bursts) or belong to a same periodicity configuration (for example, a periodicity configuration associated with a specific SSB index). As an example, in a case in which the plurality of periodicity configurations indicated by the first information are associated with different SSB bursts and each periodicity configuration includes one periodicity, the target periodicity may be a periodicity in a periodicity configuration to be activated in the plurality of periodicity configurations. As another example, in a case in which the plurality of periodicity configurations indicated by the first information are associated with different SSB indexes and each periodicity configuration includes a plurality of periodicities, the target periodicity may be a periodicity to be activated in the plurality of periodicities included in the periodicity configuration associated with the specific SSB index.

In some implementations, the second information is transmitted during a cell configuration of the terminal device, and the cell configuration includes one or more of the following: cell access, cell handover, or adding a secondary cell. That is, when a new cell is configured for the terminal device, the second information may be used to indicate a target periodicity currently activated in the plurality of periodicities. The new cell may be, for example, a new cell (or a target cell) in a process of cell access, cell handover, or adding a secondary cell.

As an example, it is assumed that the plurality of periodicities are associated with different SSB bursts, the terminal device receives the first information transmitted by the network device, where the first information indicates a plurality of periodicity configurations configured by the network device for the terminal device to receive SSB bursts, and the terminal device receives the second information transmitted by the network device, where the second information indicates a periodicity in a periodicity configuration to be activated in the plurality of periodicity configurations (that is, the target periodicity).

The target periodicity may be associated with the terminal device, that is, different terminal devices may correspond to different target periodicities. In this case, the network device may indicate, by using higher layer signalling, the target periodicity used by a currently actually transmitted SSB. Alternatively, the target periodicity may not be associated with the terminal device, that is, different terminal devices may correspond to the same target periodicity, and the target periodicity is applicable to all terminal devices in a cell or a group. In this case, the network device may indicate, by using broadcast signalling or multicast signalling, the target periodicity used by the currently actually transmitted SSB.

In some implementations, as shown in FIG. 6, the method 300 may further include Step 350 and Step 360.

In Step 350, the network device transmits third information to the terminal device.

Correspondingly, in Step 360, the terminal device receives the third information transmitted by the network device.

The third information is used to instruct adjustment of a periodicity for receiving an SSB. In other words, the third information is information indicating periodicity switching. For example, the third information may be carried in a medium access control control element (medium access control control element, MAC CE) or physical layer signalling. Optionally, a periodicity obtained after the adjustment and the periodicity before the adjustment may be periodicities in different periodicity configurations, or may be different periodicities in a same periodicity configuration. In other words, the periodicity obtained after the adjustment and the periodicity before the adjustment belong to different periodicity configurations (for example, different periodicity configurations associated with SSB bursts) or belong to a same periodicity configuration (for example, a periodicity configuration associated with a specific SSB index). As an example, in a case in which the plurality of periodicity configurations indicated by the first information are associated with different SSB bursts and each periodicity configuration includes one periodicity, the periodicity obtained after the adjustment and the periodicity before the adjustment belong to different periodicity configurations in the plurality of periodicity configurations, that is, periodicity adjustment is performed for an SSB burst, for example, periodicities used to receive the SSB burst before and after the adjustment are different. As another example, in a case in which the plurality of periodicity configurations indicated by the first information are associated with different SSB indexes and each periodicity configuration includes a plurality of periodicities, the periodicity obtained after the adjustment and the periodicity before the adjustment may belong to different periodicities in a periodicity configuration associated with a specific SSB index, that is, periodicity adjustment is performed for the SSB index, for example, periodicities used to receive an SSB having the SSB index before and after the adjustment are different.

In this case, the network device may transmit an SSB based on a switched periodicity, and correspondingly, the terminal device may also receive the SSB with the switched periodicity based on the third information. The third information may further carry information about the switched periodicity.

In some implementations, the terminal device receives, since a first instant after receiving the third information, an SSB based on the periodicity obtained after the adjustment. When the network device notifies the terminal device to perform periodicity switching by using the third information, the terminal device may immediately perform periodicity switching to receive an SSB, or after a period of time since the third information is received, the terminal device may receive an SSB based on the switched periodicity (or a new periodicity).

In some implementations, the first instant may include the following cases:
(1) a time interval between the first instant and the third information is pre-agreed;
(2) a time interval between the first instant and the third information is equal to the periodicity obtained after the adjustment;
(3) a time interval between the first instant and the last SSB transmitted before the third information is equal to the periodicity obtained after the adjustment;
(4) a time interval between the first instant and the first SSB transmitted after the third information is equal to the periodicity obtained after the adjustment;
(5) the first instant is located after a first time interval since the third information, and a time interval between the first instant and the last SSB transmitted before an end instant of the first time interval is equal to an integer multiple of the periodicity obtained after the adjustment; and
(6) the first instant is the 1^{st} instant after the third information among a plurality of periodic candidate instants, and a periodicity of the plurality of candidate instants is the periodicity obtained after the adjustment.

It should be noted that, before the first instant, SSB transmission is performed based on the periodicity before the adjustment (or an original periodicity or an old periodicity). For Case (1), an SSB may be received based on the periodicity obtained after the adjustment after a preset duration has passed since the third information is received. That is, the first instant may be an end instant of the preset duration. The preset duration may be pre-agreed, or the preset duration may be equal to the periodicity obtained after the adjustment, which is Case (2).

A difference between Case (3) and Case (4) lies that after the third information is transmitted, the network device directly transmits an SSB based on the periodicity obtained after the adjustment, or first transmits an SSB based on the periodicity before the adjustment and then transmits an SSB based on the periodicity obtained after the adjustment. If the network device directly transmits an SSB based on the periodicity obtained after the adjustment after the third information is transmitted, the time interval between the first instant and the last SSB transmitted before the third information is equal to the periodicity obtained after the adjustment, that is, the time interval between the first SSB transmitted after the third information and the last SSB transmitted before the third information is equal to the periodicity obtained after the adjustment. If the network device still needs to transmit another SSB based on the periodicity before the adjustment after the third information is transmitted, a time interval between the first instant and the last SSB transmitted after the third information is equal to the periodicity obtained after the adjustment. Correspondingly, after receiving the third information, the terminal device needs to receive an SSB based on the periodicity before the adjustment, and then receive a subsequent SSB based on the periodicity obtained after the adjustment, that is, an interval between the first SSB and the second SSB transmitted after the third information is equal to the periodicity obtained after the adjustment.

In Case (5), a condition of the first time interval is set, that is, the first instant needs to be located after the first time interval, and the time interval between the first instant and the last SSB transmitted before the end instant of the first time interval is equal to an integer multiple of the periodicity obtained after the adjustment.

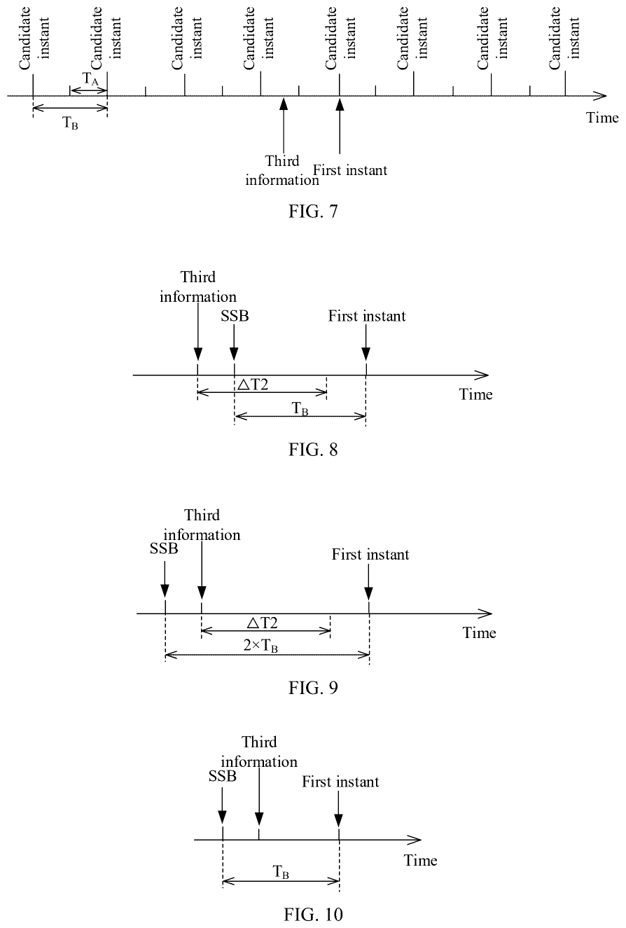

In Case (6), locations of a plurality of candidate instants distributed based on the periodicity obtained after the adjustment are determined. After receiving the third information, the terminal device searches for a candidate instant closest to the third information as the first instant, and receives, since the first instant, an SSB based on the periodicity obtained after the adjustment. As an example, as shown in FIG. 7, it is assumed that an instant when the terminal device receives the third information is T0, the periodicity before the adjustment is T_{A}, and the periodicity obtained after the adjustment is T_{B}. Then, the periodicity of the plurality of candidate instants is T_{B}, and the first instant is the first candidate instant after the instant T0.

Optionally, locations of the plurality of candidate instants are determined based on a location of a reference instant in the plurality of candidate instants, and the reference instant is, for example, pre-agreed or indicated by the network device. As an example, the reference instant may be located at a location of the first SSB among the plurality of candidate positions. The terminal device obtains the location of the first SSB, such as a slot location corresponding to the first SSB, and then determines locations of other SSBs among the plurality of candidate instants based on the location of the first SSB and the periodicity obtained after the adjustment.

In some implementations, a second time interval may be set after the third information, and the location of the first instant may be determined based on whether there is SSB transmission within the second time interval. For example, when there is SSB transmission in a second time interval since the third information, a time interval between the first instant and the last SSB transmitted in the second time interval is equal to an integer multiple of the periodicity obtained after the adjustment, and the first instant may be, for example, the 1^{st} instant that satisfies the integral multiple relationship after the second time interval. For another example, when there is no SSB transmission within the second time interval, the first instant is an end instant of the second time interval or the first instant is located after an end instant of the second time interval, the time interval between the first instant and the last SSB transmitted before the second time interval is equal to an integer multiple of the periodicity obtained after the adjustment, and the first instant is a 1^{st} instant that satisfies the integral multiple relationship after the second time interval.

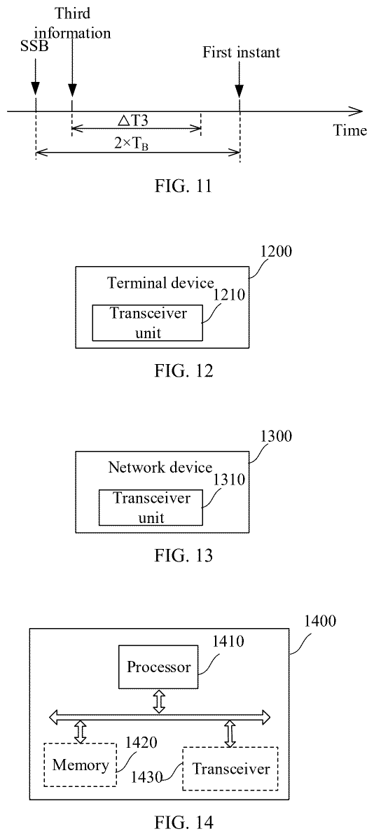

As an example, it is assumed that an instant when the terminal device receives the third information is T0, the periodicity before the adjustment is T_{A}, the periodicity obtained after the adjustment is T_{B}, and the second time interval is ΔT2. As shown in FIG. 8, if there is transmission of an SSB within ΔT2, a time interval between the first instant and the SSB within ΔT2 is T_{B}. As shown in FIG. 9, if there is no SSB transmission within ΔT2, a time interval between the first instant and the last SSB before ΔT2 is an integer multiple of T_{B}. The first instant is the 1^{st} instant that satisfies the foregoing requirements after ΔT2 ends. In FIG. 11, that the time interval between the first instant and the last SSB received before ΔT2 is twice the length of T_{B} is used as an example.

In some implementations, the location of the first instant may be determined based on a value relationship between the periodicity before the adjustment and the periodicity obtained after the adjustment. For example, when the periodicity obtained after the adjustment is less than the periodicity before the adjustment, the time interval between the first instant and the last SSB transmitted before the third information is equal to an integer multiple of the periodicity obtained after the adjustment, and the first instant is the 1^{st} instant that satisfies the integral multiple relationship after the third information. For another example, when the periodicity obtained after the adjustment is greater than the periodicity before the adjustment, the first instant is located after a second time interval since the third information, a time interval between the first instant and the last SSB received before an end instant of the second time interval is equal to an integer multiple of the periodicity obtained after the adjustment, and the first instant is the 1^{st} instant that satisfies the integral multiple relationship after the third time interval.

As an example, it is assumed that an instant when the terminal device receives the third information is T0, the periodicity before the adjustment is T_{A}, the periodicity obtained after the adjustment is T_{B}, and the third time interval is ΔT3. As shown in FIG. 10, if the periodicity obtained after the adjustment is less than the periodicity before the adjustment, it indicates that a measurement requirement of a low-latency SSB becomes greater, and a measurement period of an SSB needs to be adjusted as soon as possible. Therefore, the time interval between the first instant and the last SSB transmitted before the third information is equal to T_{B}. Actually, starting from a previous SSB that has been transmitted, SSB transmission has been performed based on a shorter new periodicity. As shown in FIG. 11, if the periodicity obtained after the adjustment is greater than the periodicity before the adjustment, a time interval between the first instant located after ΔT3 and the last SSB received before an end instant of ΔT3 is T_{B}, and the first instant is the 1^{st} instant that satisfies the foregoing requirements after the end instant of ΔT3. In FIG. 11, that the time interval between the first instant and the last SSB received before the end instant of ΔT3 is twice the length of T_{B} is used as an example.

In other implementations, a time when the third information is correctly decoded may also be considered to avoid inconsistent understanding of an SSB between the terminal device and the network device. For example, the first instant is located after the second instant, and a time interval between the first instant and the last received SSB before the second instant is an integer multiple of the periodicity obtained after the adjustment. The second instant may be an instant when it is determined that the third information is correctly decoded. For example, the third information may be an instant for transmitting or receiving ACK information for the third information.

In some implementations, the plurality of periodicity configurations indicated by the first information are associated with discontinuous transmission (discontinuous transmission, DTX) of a cell. For example, an active time corresponding to DTX corresponds to a first periodicity configuration, an inactive time corresponding to DTX corresponds to a second periodicity configuration, the first periodicity configuration includes a first periodicity, and the second periodicity configuration includes a second periodicity. Then, the first periodicity may be less than the second periodicity. That is, SSB transmission is performed based on a longer periodicity during an inactive time corresponding to DTX, and SSB transmission is performed based on a shorter periodicity during the active time corresponding to DTX. It is considered a measurement requirement of the active time, a starting point of SSB transmission with a shorter periodicity may be earlier than a starting point of the active time.

The method embodiments of the present application are described in detail above with reference to FIG. 1 to FIG. 11. Apparatus embodiments of the present application are described in detail below with reference to FIG. 12 to FIG. 14. It should be understood that the description of the method embodiments corresponds to the description of the apparatus embodiments, and therefore, for a part that is not described in detail, reference may be made to the foregoing method embodiments.

FIG. 12 is a schematic structural diagram of a terminal device according to an embodiment of the present application. A terminal device 1200 shown in FIG. 12 may include a transceiver unit 1210. The transceiver unit 1210 is configured to receive first information transmitted by a network device, where the first information indicates a plurality of periodicity configurations for receiving synchronization signal/physical broadcast channel blocks SSBs.

In some implementations, the first information is transmitted during a cell configuration of the terminal device, and the cell configuration includes one or more of the following: cell access, cell handover, or adding a secondary cell.

In some implementations, the plurality of periodicity configurations are associated with the terminal device.

In some implementations, the first information is carried in: RRC signalling; or broadcast signalling; or multicast signalling.

In some implementations, a periodicity for receiving an SSB is the same as a periodicity for transmitting an SSB by the network device; or there is an integral multiple relationship between a periodicity for receiving an SSB and a periodicity for transmitting an SSB by the network device.

In some implementations, the first information is further used to indicate a number of periodicities of continuous reception of SSBs.

In some implementations, each of the plurality of periodicity configurations includes one or more periodicities.

In some implementations, the plurality of periodicity configurations are associated with different SSB bursts; or the plurality of periodicity configurations are associated with different SSB index groups.

In some implementations, periodicities in the periodicity configurations associated with the different SSB index groups are different.

In some implementations, different periodicity configurations in the plurality of periodicity configurations include periodicities having an integral multiple relationship; and/or a same periodicity configuration in the plurality of periodicity configurations includes periodicities having an integral multiple relationship.

In some implementations, the transceiver unit 1210 is further configured to receive second information transmitted by the network device, where the second information is used to indicate a target periodicity to be activated in a plurality of periodicities, and the plurality of periodicities are periodicities in different periodicity configurations, or are different periodicities in a same periodicity configuration.

In some implementations, the second information is transmitted during a cell configuration of the terminal device, and the cell configuration includes one or more of the following: cell access, cell handover, or adding a secondary cell.

In some implementations, the target periodicity is associated with the terminal device.

In some implementations, the transceiver unit 1210 is further configured to receive third information transmitted by the network device, where the third information is used to instruct adjustment of a periodicity for receiving an SSB, where a periodicity obtained after the adjustment and the periodicity before the adjustment are periodicities in different periodicity configurations, or are different periodicities in a same periodicity configuration.

In some implementations, the third information is carried in: a medium access control control element MAC CE; or physical layer signalling.

In some implementations, the transceiver unit 1210 is further configured to receive, since a first instant after receiving the third information, an SSB based on the periodicity obtained after the adjustment.

In some implementations, a time interval between the first instant and the third information is pre-agreed; or a time interval between the first instant and the third information is equal to the periodicity obtained after the adjustment; or a time interval between the first instant and the last SSB transmitted before the third information is equal to the periodicity obtained after the adjustment; or a time interval between the first instant and the first SSB transmitted after the third information is equal to the periodicity obtained after the adjustment; or the first instant is located after a first time interval since the third information, and a time interval between the first instant and the last SSB transmitted before an end instant of the first time interval is equal to an integer multiple of the periodicity obtained after the adjustment; or the first instant is the 1^{st} instant after the third information among a plurality of periodic candidate instants, and a periodicity of the plurality of candidate instants is the periodicity obtained after the adjustment.

In some implementations, locations of the plurality of candidate instants are determined based on a location of a reference instant in the plurality of candidate instants, and the reference instant is pre-agreed.

In some implementations, when there is SSB transmission in a second time interval since the third information, a time interval between the first instant and the last SSB transmitted in the second time interval is equal to an integer multiple of the periodicity obtained after the adjustment, and the first instant is the 1^{st} instant that satisfies the integral multiple relationship after the second time interval; and when there is no SSB transmission within the second time interval, the first instant is an end instant of the second time interval or the first instant is located after an end instant of the second time interval, the time interval between the first instant and the last SSB transmitted before the second time interval is equal to an integer multiple of the periodicity obtained after the adjustment, and the first instant is the 1^{st} instant that satisfies the integral multiple relationship after the second time interval.

In some implementations, when the periodicity obtained after the adjustment is less than the periodicity before the adjustment, the time interval between the first instant and the last SSB transmitted before the third information is equal to an integer multiple of the periodicity obtained after the adjustment, and the first instant is the 1^{st} instant that satisfies the integral multiple relationship after the third information; and/or when the periodicity obtained after the adjustment is greater than the periodicity before the adjustment, the first instant is located after a third time interval since the third information, a time interval between the first instant and the last SSB received before an end instant of the third time interval is equal to an integer multiple of the periodicity obtained after the adjustment, and the first instant is the 1^{st} instant that satisfies the integral multiple relationship after the third time interval.

It may be understood that the transceiver unit 1210 may be, for example, a transceiver 1430. In addition, optionally, the terminal device 1200 further includes a processor 1410 and a memory 1420. For details, refer to FIG. 14.

FIG. 13 is a schematic structural diagram of a network device according to an embodiment of the present application. A network device 1300 shown in FIG. 13 may include a transceiver unit 1310. The transceiver unit 1310 is configured to transmit first information to a terminal device, where the first information indicates a plurality of periodicity configurations for receiving synchronization signal/physical broadcast channel blocks SSBs.

In some implementations, the first information is transmitted during a cell configuration of the terminal device, and the cell configuration includes one or more of the following: cell access, cell handover, or adding a secondary cell.

In some implementations, the plurality of periodicity configurations are associated with the terminal device.

In some implementations, the first information is carried in: radio resource control RRC signalling; or broadcast signalling; or multicast signalling.

In some implementations, a periodicity for receiving an SSB is the same as a periodicity for transmitting an SSB by the network device; or there is an integral multiple relationship between a periodicity for receiving an SSB and a periodicity for transmitting an SSB by the network device.

In some implementations, the first information is further used to indicate a number of periodicities of continuous reception of SSBs.

In some implementations, each of the plurality of periodicity configurations includes one or more periodicities.

In some implementations, the plurality of periodicity configurations are associated with different SSB bursts; or the plurality of periodicity configurations are associated with different SSB index groups.

In some implementations, periodicities in the periodicity configurations associated with the different SSB index groups are different.

In some implementations, different periodicity configurations in the plurality of periodicity configurations include periodicities having an integral multiple relationship; and/or a same periodicity configuration in the plurality of periodicity configurations includes periodicities having an integral multiple relationship.

In some implementations, the transceiver unit 1310 is further configured to transmit second information to the terminal device, where the second information is used to indicate a target periodicity to be activated in a plurality of periodicities, and the plurality of periodicities are periodicities in different periodicity configurations, or are different periodicities in a same periodicity configuration.

In some implementations, the second information is transmitted during a cell configuration of the terminal device, and the cell configuration includes one or more of the following: cell access, cell handover, or adding a secondary cell.

In some implementations, the target periodicity is associated with the terminal device.

In some implementations, the transceiver unit 1310 is further configured to transmit third information to the terminal device, where the third information is used to instruct adjustment of a periodicity for receiving an SSB, where a periodicity obtained after the adjustment and the periodicity before the adjustment are periodicities in different periodicity configurations, or are different periodicities in a same periodicity configuration.

In some implementations, the third information is carried in: a medium access control control element MAC CE; or physical layer signalling.

In some implementations, the transceiver unit 1310 is further configured to transmit, since a first instant after transmitting the third information, an SSB based on the periodicity obtained after the adjustment.

In some implementations, a time interval between the first instant and the third information is pre-agreed; or a time interval between the first instant and the third information is equal to the periodicity obtained after the adjustment; or a time interval between the first instant and the last SSB transmitted before the third information is equal to the periodicity obtained after the adjustment; or a time interval between the first instant and the first SSB transmitted after the third information is equal to the periodicity obtained after the adjustment; or the first instant is located after a first time interval since the third information, and a time interval between the first instant and the last SSB transmitted before an end instant of the first time interval is equal to an integer multiple of the periodicity obtained after the adjustment; or the first instant is the 1^{st} instant after the third information among a plurality of periodic candidate instants, and a periodicity of the plurality of candidate instants is the periodicity obtained after the adjustment.

In some implementations, locations of the plurality of candidate instants are determined based on a location of a reference instant in the plurality of candidate instants, and the reference instant is pre-agreed.

In some implementations, when there is SSB transmission in a second time interval since the third information, a time interval between the first instant and the last SSB transmitted in the second time interval is equal to an integer multiple of the periodicity obtained after the adjustment, and the first instant is the 1^{st} instant that satisfies the integral multiple relationship after the second time interval; and when there is no SSB transmission within the second time interval, the first instant is an end instant of the second time interval or the first instant is located after an end instant of the second time interval, the time interval between the first instant and the last SSB transmitted before the second time interval is equal to an integer multiple of the periodicity obtained after the adjustment, and the first instant is the 1^{st} instant that satisfies the integral multiple relationship after the second time interval.

In some implementations, when the periodicity obtained after the adjustment is less than the periodicity before the adjustment, the time interval between the first instant and the last SSB transmitted before the third information is equal to an integer multiple of the periodicity obtained after the adjustment, and the first instant is the 1^{st} instant that satisfies the integral multiple relationship after the third information; and/or when the periodicity obtained after the adjustment is greater than the periodicity before the adjustment, the first instant is located after a third time interval since the third information, a time interval between the first instant and the last SSB received before an end instant of the third time interval is equal to an integer multiple of the periodicity obtained after the adjustment, and the first instant is the 1^{st} instant that satisfies the integral multiple relationship after the third time interval.

It may be understood that the transceiver unit 1310 may be, for example, a transceiver 1430. In addition, optionally, the network device 1300 further includes a processor 1410 and a memory 1420. For details, refer to FIG. 14.

FIG. 14 is a schematic structural diagram of an apparatus for communication according to an embodiment of the present application. Dashed lines shown in FIG. 14 indicate that the unit or module is optional. An apparatus 1400 may be configured to implement the methods described in the foregoing method embodiments. The apparatus 1400 may be, for example, a chip, a terminal device, or a network device.

The apparatus 1400 may include one or more processors 1410. The processor 1410 may allow the apparatus 1400 to implement the methods described in the foregoing method embodiments. The processor 1410 may be a general-purpose processor or a dedicated processor. For example, the processor 1410 may be a central processing unit (central processing unit, CPU). Alternatively, the processor 1410 may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or may be any conventional processor or the like.

The apparatus 1400 may further include one or more memories 1420. The memory 1420 stores a program, and the program may be executed by the processor 1410, so that the processor 1410 performs a method described in the foregoing method embodiments. The memory 1420 may be separate from the processor 1410 or may be integrated into the processor 1410.

The apparatus 1400 may further include a transceiver 1430. The processor 1410 may communicate with another device or chip by using the transceiver 1430. For example, the processor 1410 may transmit data to and receive data from another device or chip by using the transceiver 1430.

An embodiment of the present application further provides a communications system. The communications system includes the terminal device and the network device described above. In some implementations, the system further includes another device that interacts with the terminal device and the network device.

An embodiment of the present application further provides a computer-readable storage medium for storing a program. The computer-readable storage medium may be applied to the terminal device or the network device provided in embodiments of the present application, and the program causes a computer to perform a method performed by the terminal device or the network device in various embodiments of the present application.

An embodiment of the present application further provides a computer program product. The computer program product includes a program. The computer program product may be applied to the terminal device or the network device provided in embodiments of the present application, and the program causes a computer to perform a method performed by the terminal device or the network device in various embodiments of the present application.

An embodiment of the present application further provides a computer program. The computer program may be applied to the terminal device or the network device provided in embodiments of the present application, and the computer program causes a computer to perform a method performed by the terminal device or the network device in various embodiments of the present application.

It should be understood that the terms “system” and “network” in embodiments of the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular order. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, “B corresponding to A” means that B is associated with A, and B may be determined based on A. However, it should be further understood that, determining B based on A does not mean determining B based only on A, but instead, B may be determined based on A and/or other information.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, “pre-defined” or “pre-configured” may be implemented by pre-storing corresponding code, tables, or other forms that may be used to indicate related information in devices (for example, including a terminal device and a network device), and a specific implementation thereof is not limited in the present application. For example, being pre-defined may refer to being defined in a protocol.

In embodiments of the present application, the “protocol” may refer to a standard protocol in the communications field, and may include, for example, an LTE protocol, an NR protocol, and a related protocol applied to a future communications system, which is not limited in the present application.

In embodiments of the present application, the term “and/or” is merely an association relationship that describes associated objects, and represents that there may be three relationships. For example, A and/or B may represent three cases: Only A exists, both A and B exist, and only B exists. In addition, the character “/” in this specification generally indicates an “or” relationship between the associated objects.

In embodiments of the present application, sequence numbers of the foregoing processes do not mean execution sequences. The execution sequences of the processes should be determined according to functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. Indirect couplings or communication connections between apparatuses or units may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objectives of the solutions of embodiments.

In addition, functional units in embodiments of the present application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of the embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital versatile disc (digital video disc, DVD)), a semiconductor medium (for example, a solid-state drive (solid state disk, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A wireless communication method, comprising:
receiving, by a terminal device, first information from a network device, wherein the first information indicates a plurality of periodicity configurations for receiving synchronization signal/physical broadcast channel blocks (SSBs).

2. The method according to claim 1, wherein the first information is received during a cell configuration of the terminal device, and the cell configuration comprises one or more of the following: cell access, cell handover, or adding a secondary cell.

3. The method according to claim 1, wherein the plurality of periodicity configurations are associated with the terminal device, and wherein the first information is carried in:
radio resource control (RRC) signalling; or
broadcast signalling; or
multicast signalling.

4. The method according to claim 1, wherein
a periodicity for receiving an SSB is the same as a periodicity for transmitting an SSB by the network device; or
there is an integral multiple relationship between a periodicity for receiving an SSB and a periodicity for transmitting an SSB by the network device.

5. The method according to claim 1, wherein the first information indicates a number of periodicities of continuous reception of SSBs.

6. The method according to claim 1, wherein each of the plurality of periodicity configurations comprises one or more periodicities.

7. The method according to claim 1, wherein
the plurality of periodicity configurations are associated with different SSB bursts; or
the plurality of periodicity configurations are associated with different SSB index groups.

8. The method according to claim 7, wherein periodicities in the periodicity configurations associated with the different SSB index groups are different.

9. The method according to claim 1, wherein different periodicity configurations in the plurality of periodicity configurations comprise periodicities having an integral multiple relationship; or a same periodicity configuration in the plurality of periodicity configurations comprises periodicities having an integral multiple relationship.

10. The method according to claim 1, wherein the method further comprises:
receiving, by the terminal device, second information from the network device, wherein the second information indicates a target periodicity to be activated in a plurality of periodicities, and the plurality of periodicities are periodicities in different periodicity configurations, or are different periodicities in a same periodicity configuration.

11. The method according to claim 10, wherein the second information is received during a cell configuration of the terminal device, and the cell configuration comprises one or more of the following: cell access, cell handover, or adding a secondary cell.

12. The method according to claim 10, wherein the target periodicity is associated with the terminal device.

13. The method according to claim 1, wherein the method further comprises:
receiving, by the terminal device, third information from the network device, wherein the third information is used to instruct adjustment of a periodicity for receiving an SSB, wherein a periodicity obtained after the adjustment and the periodicity before the adjustment are periodicities in different periodicity configurations, or are different periodicities in a same periodicity configuration.

14. The method according to claim 13, wherein the third information is carried in:
a medium access control control element (MAC CE); or
physical layer signalling.

15. The method according to claim 13, wherein the method further comprises:
receiving, by the terminal device since a first instant after receiving the third information, an SSB based on the periodicity obtained after the adjustment.

16. The method according to claim 15, wherein
a time interval between the first instant and the third information is pre-agreed; or
a time interval between the first instant and the third information is equal to the periodicity obtained after the adjustment; or
a time interval between the first instant and a last SSB transmitted before the third information is equal to the periodicity obtained after the adjustment; or
a time interval between the first instant and a first SSB transmitted after the third information is equal to the periodicity obtained after the adjustment; or
the first instant is located after a first time interval since the third information, and a time interval between the first instant and a last SSB transmitted before an end instant of the first time interval is equal to an integer multiple of the periodicity obtained after the adjustment; or
the first instant is a 1^{st} instant after the third information among a plurality of periodic candidate instants, and a periodicity of the plurality of periodic candidate instants is the periodicity obtained after the adjustment.

17. The method according to claim 16, wherein locations of the plurality of candidate instants are determined based on a location of a reference instant in the plurality of candidate instants, and the reference instant is pre-agreed.

18. The method according to claim 16, wherein
when there is SSB transmission in a second time interval since the third information, a time interval between the first instant and a last SSB transmitted in the second time interval is equal to an integer multiple of the periodicity obtained after the adjustment, and the first instant is a 1^{st} instant that satisfies an integral multiple relationship after the second time interval; or
when there is no SSB transmission within the second time interval, the first instant is an end instant of the second time interval or the first instant is located after an end instant of the second time interval, the time interval between the first instant and the last SSB transmitted before the second time interval is equal to an integer multiple of the periodicity obtained after the adjustment, and the first instant is a 1^{st} instant that satisfies the integral multiple relationship after the second time interval.

19. The method according to claim 16, wherein
when the periodicity obtained after the adjustment is less than the periodicity before the adjustment, the time interval between the first instant and the last SSB transmitted before the third information is equal to an integer multiple of the periodicity obtained after the adjustment, and the first instant is a 1^{st} instant that satisfies an integral multiple relationship after the third information; or
when the periodicity obtained after the adjustment is greater than the periodicity before the adjustment, the first instant is located after a third time interval since the third information, a time interval between the first instant and a last SSB received before an end instant of the third time interval is equal to an integer multiple of the periodicity obtained after the adjustment, and the first instant is a 1^{st} instant that satisfies the integral multiple relationship after the third time interval.

20. A wireless communication method, comprising:
transmitting, by a network device, first information to a terminal device, wherein the first information indicates a plurality of periodicity configurations for receiving synchronization signal/physical broadcast channel blocks (SSBs).
